(19) United States
(12) Patent Application Publication
(10) Pub. No.: US 2003/0110674 A1
(43) Pub. Date: Jun. 19, 2003

(54) Customizable place mat assembly

(75) Inventor: Vicki Ernst, West Nyack, NY (US)

Correspondence Address: STEINBERG & RASKIN, P.C., 1140 AVENUE OF THE AMERICAS, 15th FLOOR, NEW YORK, NY, 10036-5803, US

(73) Assignee: CRAFTIMAT, INC.

(21) Appl. No.: 10/022,792

(22) Filed: Dec. 13, 2001

(51) Int. Cl. A47G 1/06; B32B 3/00

(52) U.S. Cl. 40/773; 428/195

(57) ABSTRACT

A customizable place mat assembly capable of displaying a plurality of substantially planar objects. The place mat assembly includes a substantially continuous base sheet having a first surface and a second surface, at least one of the surfaces having an adhesive layer applied thereto for retaining the planar objects on the base sheet. The place mat assembly also includes a substantially continuous transparent cover sheet structured and arranged to sealably secure the planar objects between the base sheet and the cover sheet.

### FIELD OF THE INVENTION

The present invention relates generally to place mats and, in particular, to customizable place mats for visually displaying planar objects of varying sizes and shapes.

### BACKGROUND OF THE INVENTION

Place mats are available in a variety of shapes, colors, designs and materials to suit the desires of the user. For example, place mats exist for use during formal occasions as well as for less formal occasions. Place mats formed from plastic exist for use by children who are prone to create a mess during meals while place mats formed from fine fabrics exist for use by adults. Place mats also exist which are aimed primarily at entertaining the user, in addition to protecting the surface on which they are placed. For example, place mats exist which include familiar cartoon characters printed thereon.

However, while place mats exist which might be directed towards a particular class of individuals, e.g., adults or children, place mats are generally mass produced and are therefore not customized to each individual user. It is generally not possible for a user to customize his or her place mat to include photos of friends or family members or mementos from a special occasion. This presents a problem since individuals enjoy using items which are customized to their own particular likes. Attempts have been made to fill this void as discussed below.

U.S. Pat. No. 5,096,752 to Wagner appears to disclose a place mat having pockets for holding celebrity cards such as baseball cards. Specifically, the mat purportedly includes a front panel having a plurality of rectangular cut outs dimensioned to accommodate cards bearing the likeness of celebrities such as athletes. Each of the cut outs is covered with a clear plastic film overlay to provide a window for viewing the cards. A base panel is laminated to the front panel and encloses the cut outs to form a pocket for each card. Provided in the base panel adjacent an edge of each cut out is a slot for insertion and removal of cards. The front panel is imprinted with indicia coordinated with the activity of the celebrities on the cards to be inserted in the various pockets.

U.S. Pat. No. 4,510,006 to Lawson purports to disclose a personalized laminated display for use as a poster or a place mat which includes a backing sheet having a selected photograph adhesively applied thereto and two sheets of transparent plastic film encasing the backing sheet, i.e., the backing sheet is laminated using a professional laminating machine.

While these patents purport to disclose customizable place mats, drawbacks exist with the arrangements disclosed in each. With regard to the arrangement disclosed by Wagner, among other drawbacks, since the place mat is formed having discrete pockets formed in the front panel, the place mat is limited with regard to the sizes and shapes of the items to be displayed. The user is required to choose items which are able to fit within the pockets provided by the manufacturer. In addition, the user is restricted as to how the items can be arranged on the place mat. The items must be placed within the pockets or slots provided in the front panel. Moreover, the use of pockets in the front panel does not appear to provide a fluid-tight seal for the baseball cards inserted into the pockets such that the place mat cannot be washed without contaminating the baseball cards.

With regard to the arrangement of Lawson, among other drawbacks, since the method of forming the place mat requires the use of a professional lamination machine, it is not possible for users to customize their place mats at home. It therefore would not be possible to purchase the place mat of Lawson as a gift for a friend or family member without first customizing the place mat.

### OBJECTS AND SUMMARY OF THE INVENTION

It is therefore an object of the present invention to avoid the above drawbacks of current place mat assemblies.

It is another object of the present invention to provide a new and improved place mat assembly which is capable of being customized for a particular user.

It is yet another object of the present invention to provide a new and improved place mat assembly which is capable of being customized to display photographs and mementos having varying sizes and shapes.

It is still another object of the present invention to provide a new and improved place mat assembly which is capable of being customized to display photographs and mementos in various arrangements.

It is a further object of the present invention to provide a new and improved place mat assembly which is capable of being customized to display photographs and mementos in a fluid-tight manner such that the place mat can be washed without contaminating the photographs and mementos.

It is another object of the present invention to provide a new and improved place mat assembly which is capable of being customized to display photographs and mementos and which can be so customized by both children and adults at their homes.

It is another object of the present invention to provide a new and improved place mat assembly which is capable of being customized so that it can be used to aid in the education of young children during meals.

To achieve these objects, and others, a place mat assembly is provided which is capable of displaying a plurality of substantially planar objects having various shapes and sizes. The place mat assembly includes a substantially continuous base sheet having a first surface and a second surface, at least one of the surfaces having an adhesive layer applied thereto for retaining the planar objects on the base sheet. The place mat assembly also includes a substantially continuous transparent cover sheet structured and arranged to sealably secure the planar objects between the base sheet and the cover sheet.

In the preferred embodiment of the invention, the planar objects consist of any objects capable of being sealed between the base sheet and cover sheet including, but not limited to, photographs, letters, poems, wedding invitations, dried flowers, business cards, etc. Since the objects are adhered to the base sheet without the use of discrete pockets or the like, the objects can be of varying sizes and shapes. In addition, the objects can be arranged on the base sheet in any manner desired by the user such as in a collage.

The objects are typically chosen so that the place mat takes on a particular theme. For example, the place mat can be customized so that it includes photographs of family members. The place mat can also be customized so that it acts as a memento from a particular occasion such as a wedding or a vacation. The place mat can also be customized to exhibit the user's hobbies and/or collections.

The base sheet of the place mat assembly is formed from an opaque rigid plastic material, preferably calendered rigid vinyl, having one of a variety of colors. For example, the base sheet can be white, black, red, yellow, blue, green, purple, orange, or any other color desired to form the background of the planar objects placed thereon. The cover sheet is formed from a transparent plastic material, preferably transparent calendered vinyl. The base and cover sheets are formed to have lengths ranging from approximately 15 to 19 inches and widths ranging from approximately 9 to 13 inches. The base sheet is approximately 1 to 2 millimeters thick and the cover sheet is approximately 0.5 to 2 millimeter thick. The corners of the base and cover sheets are preferably rounded to protect the user from injury.

The place mat assembly further includes a paper backing sheet applied to the adhesive layer of the base sheet which, as discussed further below, is peeled back when customizing the place mat assembly. The adhesive forming the adhesive layer is a double-sided pressure sensitive adhesive, preferably acrylic transfer tape. Such an adhesive is known to those skilled in the art as being strong enough to sealably secure the cover sheet to the base sheet to thereby secure the planar objects between the base sheet and the cover sheet in a fluid-tight manner. In other words, the adhesive is strong enough to provide a fluid-tight seal between the base and cover sheets such that the place mat can be washed without contaminating the planar objects arranged between the base and cover sheets. Indeed, the adhesive is so strong that, once the cover sheet is placed on the base sheet to cover the planar objects, the cover sheet cannot be removed from the base sheet without damaging the place mat.

The place mat assembly of the present invention is customized by first choosing objects to be arranged on the adhesive layer of the base sheet. The objects can be of varying shapes and sizes and will typically relate to one another so that the place mat takes on a particular theme. The paper backing sheet is then peeled back from the base sheet exposing the adhesive layer, after which the objects are arranged on the adhesive layer. The objects can be arranged in any manner desired by the user. Lastly, the transparent cover sheet is laid on top of the base sheet thereby sealably retaining the objects between the base and cover sheets.

The place mat assembly is sold as a kit, with the base sheet and cover sheet being two separate and distinct components. The cover sheet and base sheet are sold together in a plastic bag, box, or the like. However, in alternate embodiments of the invention, the cover sheet is hingedly coupled to the base sheet along one of their respective edges.

Accordingly, with the place mat assembly of the present invention, individuals are able to create customized place mats which display photographs and mementos of varying shapes and sizes in a fluid-tight manner such that the place mat can be washed without contaminating the photographs and mementos. The place mat assembly of the present invention is sold as a kit and is customizable by users at home or at work. The photographs and mementos can be arranged on the place mat in various ways.

In another embodiment of the invention, a method of making a place mat for displaying substantially planar objects, e.g, photographs, mementos and the like, is provided which includes the steps of providing a substantially continuous base sheet having a first surface and a second surface, at least one of the surfaces having an adhesive layer applied thereto, selecting the planar objects having any sizes or shapes for arrangement on the adhesive layer of the base sheet, positioning the planar objects on any area of the adhesive layer of the base sheet, providing at least one substantially continuous transparent cover sheet, and laying the transparent cover sheet over the sheet to thereby sealably secure the planar objects between the base sheet and the cover sheet.

In another embodiment of the invention, a place mat assembly for displaying substantially planar objects is provided which has a first position and a second position. The place mat assembly includes a substantially continuous base sheet having a first surface, a second surface, a top edge, a bottom edge opposed to the top edge, and opposed side edges, at least one of the surfaces having an adhesive layer applied thereto. The place mat assembly also includes a transparent cover sheet having a top edge, a bottom edge opposed to the top edge, and opposed side edges, wherein the top edge of said cover sheet is hingedly coupled to the top edge of the base sheet such that when the place mat is in its first position, the bottom edge of the cover sheet is spaced apart from the bottom edge of the base sheet such that the planar object is able to be positioned and retained on the adhesive layer of the base sheet. When the place mat assembly is in its second position, the bottom edge of the cover sheet is flush with the bottom edge of the base sheet such that the planar object is sealably retained between the base sheet and the cover sheet.

In another embodiment of the invention, a method for protecting a table top during meals is provided including the steps of providing a substantially continuous base sheet having a first surface and a second surface, at least one of the surfaces having an adhesive layer applied thereto, selecting planar objects for arrangement on the adhesive layer of the base sheet, positioning the planar objects on the adhesive layer of the base sheet, providing a transparent cover sheet, laying the transparent cover sheet over the continuous base sheet to thereby sealably secure the planar objects between the base sheet and the transparent cover sheet and to thereby form a place mat, placing the place mat on a surface of a table, and placing dishes and the like on the place mat.

In another embodiment of the invention, the objects placed between the base sheet and cover sheet are educational objects such that a method for educating a young child during meals is provided. In this method of the invention, a substantially continuous base sheet is provided having a first surface and a second surface, at least one of the surfaces having an adhesive layer applied thereto. Planar objects having educational values are then selected for arrangement on the adhesive layer of the base sheet. Such educational objects include, for example, the letters of the alphabet, numbers, shapes, simple words with corresponding objects, and the like. The educational planar objects are positioned on the adhesive layer of the base sheet and a transparent cover sheet is laid on the continuous base sheet to thereby sealably secure the educational planar objects between the base sheet and the transparent cover sheet to thereby form a place mat. The place mat is laid on a surface of a table and dishes and the like are placed on the place mat. The young child is then quizzed during the meal using the educational planar objects of the place mat.

### BRIEF DESCRIPTION OF THE DRAWINGS

A more complete appreciation of the present invention and many of the attendant advantages thereof will be readily understood by reference to the following detailed description when considered in connection with the accompanying drawings in which:

FIG. 1 is an exploded perspective view of a place mat assembly in accordance with the invention;

FIG. 2 is a plan view of the place mat assembly shown in FIG. 1;

FIG. 3 is a cross-sectional view along line 3-3 of FIG. 2;

FIG. 4 is a perspective view of a place mat assembly in accordance with another embodiment of the invention;

FIG. 5 is a plan view of a place mat assembly in accordance with an another embodiment of the invention;

FIG. 6 is a perspective view of the place mat assembly shown in FIG. 5 being used; and

FIG. 7 is a front view of a place mat assembly in accordance with the invention as sold in stores.

### DETAILED DESCRIPTION OF THE INVENTION

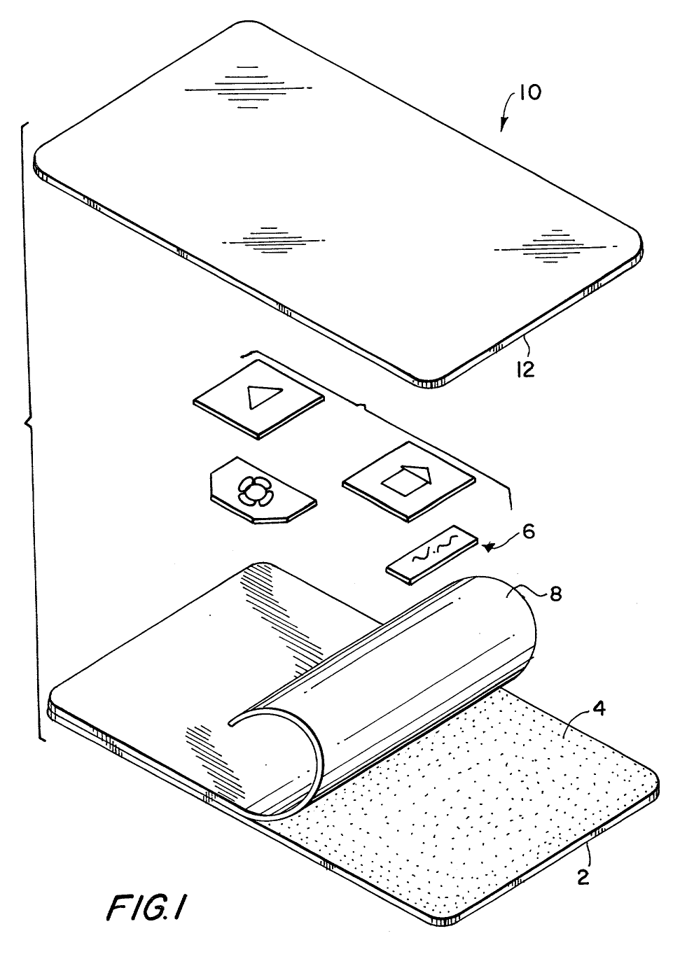

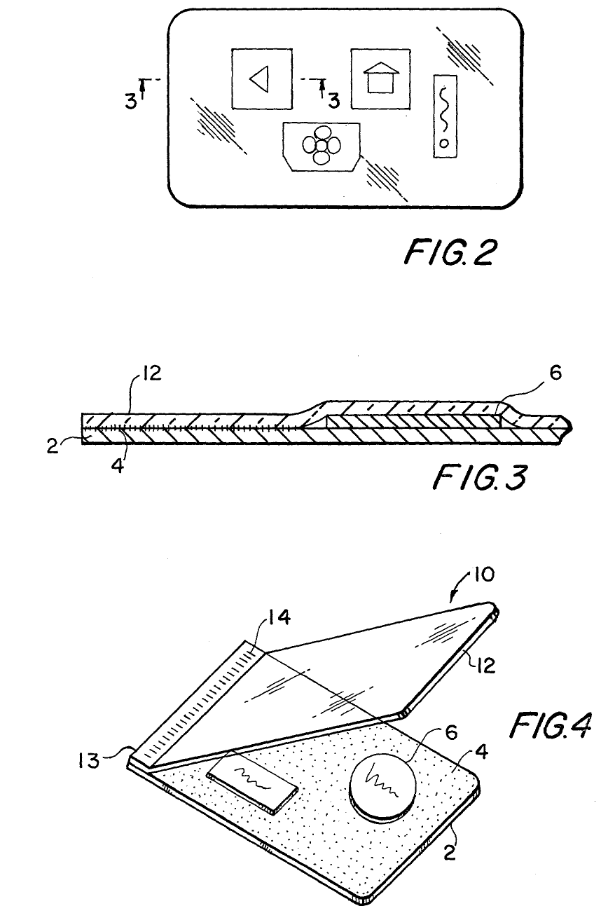

Referring to the drawings, wherein like reference characters designate identical or corresponding parts throughout the various views, FIGS. 1-3 show a place mat assembly 10 in accordance with the present invention which is capable of being customized to display one or more planar objects 6 such as photographs, letters, poems, wedding invitations, dried flowers, business cards, educational items and the like. As discussed below, place mat assembly 10 is designed such that planar objects 6 can be of varying sizes and shapes and can be arranged in any manner.

Place mat assembly 10 includes a base sheet 2 and cover sheet 4. Base sheet 2 is formed from a rigid opaque plastic material, preferably calendered rigid vinyl, having a matte finish on both sides. The base sheet 2 can be any color, including white, black, red, yellow, blue, green, purple, orange, or any other color desired to form the background of the place mat. The base sheet 2 is rectangular in shape having a width of between approximately 9 and 13 inches, preferably 11 inches, and a length of between approximately 15 and 19 inches, preferably 17 inches. The thickness of base sheet 2 is approximately 1 to 2 millimeters. The corners of the base sheet 2 are rounded so that the user is not easily injured. While the base sheet 2 is preferably substantially rectangular in shape, it can also be other shapes known by those skilled in the art to be used for place mats such as square, round and oval.

The base sheet 2 of place mat 10 includes a layer of adhesive 4 covering substantially one entire surface of base sheet 2. The adhesive is a double sided pressure sensitive adhesive, preferably acrylic transfer tape, which is known in the art to be a relatively strong adhesive. While the adhesive layer 4 preferably covers substantially one entire surface of base sheet 2, in other embodiments of the invention, the adhesive layer only covers a portion of one surface of base sheet 2 such that a narrow border remains around the periphery of the base sheet.

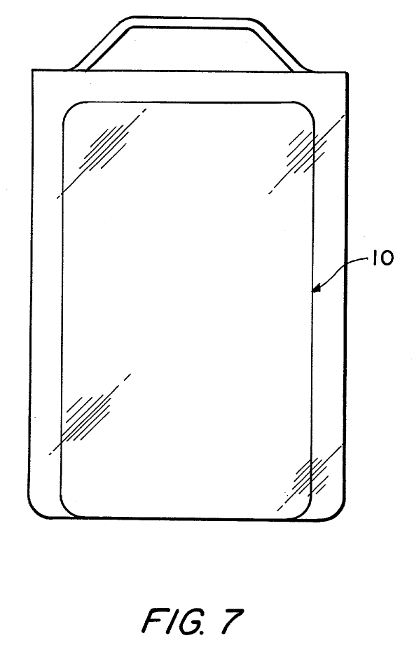

A backing sheet 8 is applied to the exposed side of the adhesive layer 4 of base sheet 2. That is, when the place mat assembly 10 is sold as a kit (see FIG. 7), i.e., prior to the customization of the place mat assembly to form the customized place mat, the base sheet 2 includes a backing sheet 8 applied over the entire adhesive layer 4. Backing sheet 8 is a waxy paper material which is easily releasable from the adhesive layer.

Place mat assembly 10 also includes a cover sheet 12 which is structured and arranged to be laid on top of adhesive layer 4 when the place mat assembly 10 is customized to form a place mat. Cover sheet 12 is a transparent plastic material, preferably transparent calendered vinyl. Cover sheet 12 is formed to have substantially the same dimensions as base sheet 2 except that the thickness of cover sheet 12 is approximately 0.5 to 2 millimeters. The corners of cover sheet 12 are also rounded to prevent injury to the user.

In alternate embodiments of the invention, the base and cover sheets can have dimensions which are larger or smaller than the dimensions stated above. For example, the base and cover sheets can be formed to have larger dimensions than stated above such that the place mat can be used as a blotter for an office desk.

Both the cover sheet 12 and base sheet 2 are substantially continuous. That is, the cover sheet 12 and base sheet 2 are devoid of perforations or holes such that the objects placed therebetween will be sealably retained when the place mat is formed. This is important since it is a goal of the present invention to keep the objects free from contamination when the place mat is being washed.

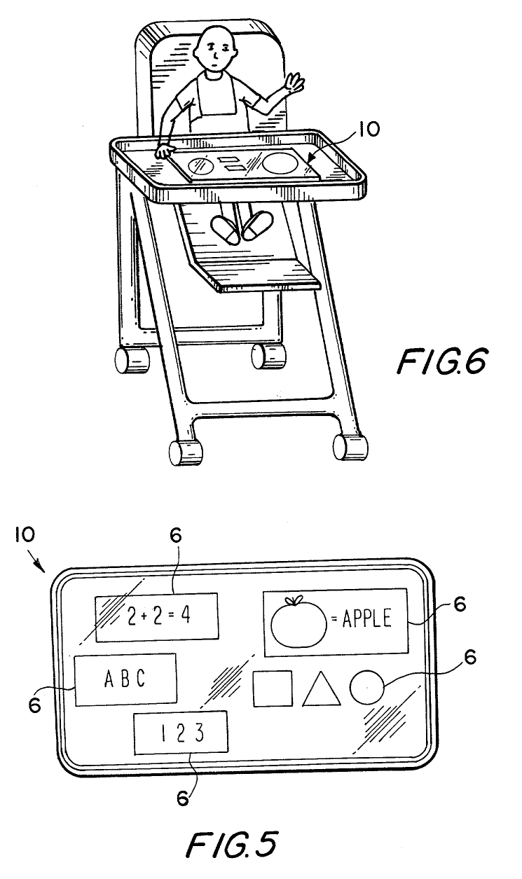

The method of customizing the place mat assembly 10 will now be discussed. Place mat assembly 10 is sold as a kit (see FIG. 7) such that base sheet 2, having the adhesive layer 4 and backing sheet 8 applied thereto, and cover sheet 12 are separate and distinct components. As discussed further below, in another embodiment of the invention, base sheet 2 and cover sheet 12 are hingedly coupled to one another along respective edges of each sheet (see FIG. 4). The place mat assembly 10 is typically sold in a transparent plastic bag. However, it is understood by those skilled in the art that the place mat assembly 10 can be sold in other packages such as a box or large envelope.

After removing the components of place mat assembly 10 from the package, the user chooses at least one, preferably several, planar objects 6 to be displayed by the place mat. For example, if the place mat is being customized for use by a young child, the user might choose several photographs of the child's family members so that, during meals, the child can be quizzed as to the name of each family member. Alternatively, the user might choose to customize the place mat so that it includes mementos from a vacation or special occasion such as a wedding. Such mementos can include photographs from the wedding, the wedding invitation, a dried flower from the bride's bouquet, and a piece of the bride's veil. It is an important aspect of the place mat assembly 10 of the invention that the objects 6 chosen by the user can be of varying sizes and shapes. The user is not limited to objects of uniform sizes as with prior art place mats. Alternate objects 6 for use with place mat assembly 10 will be discussed further below in connection with alternate embodiments of the invention.

After objects 6 are chosen, backing sheet 8 is peeled off from base sheet 2 to expose the adhesive layer 4 and the objects 6 are arranged on the adhesive layer 4. It is an important aspect of the place mat assembly 10 of the invention that the objects 6 chosen by the user can be arranged on the base sheet 2 in any desired manner. In contrast to prior art place mats, the user is not confined to placing the objects 6 in predetermined slots or pockets provided in the backing sheet. However, it is pointed out that the objects 6 must not cover the entire adhesive layer 4 since at least a portion of adhesive layer 4 around the periphery of the base sheet 2 must remain exposed so that the cover sheet 12 can adhere to the base sheet 2 and sealably retain the objects 6 between the sheets in a fluid-tight manner. It is preferred that a border of between approximately 0.5 and 1.5 inches remain around the periphery of the base sheet 2.

After objects 6 are arranged on the adhesive layer 4, the cover sheet 12 is placed on top of base sheet 2 such that cover sheet 12 adheres to the exposed portions of the adhesive layer 4 and the objects 6 are sealably retained between base sheet 2 and cover sheet 12 in a fluid-tight manner. It is important that cover sheet 12 is positioned on base sheet 2 such that the respective edges of each sheet are perfectly aligned. At this stage of the process, a customized place mat is provided which can be washed without the possibility of contaminating the objects 6 since the objects 6 are sealed between base sheet 2 and cover sheet 12 in a fluid-tight manner. As shown in FIG. 3, the adhesive used to form adhesive layer 4 is so strong that the portions of the base and cover sheets surrounding each object 6 are adhered together to form a barrier to fluids during meals and when washing the place mat. In this manner, the place mat assembly 10 is not reusable such that it can only be customized a single time.

FIG. 4 shows another embodiment of the place mat assembly 10 of the present invention. The place mat assembly 10 of this embodiment is similar to the place mat assembly of FIGS. 1-3 except that the place mat assembly 10 of FIG. 4 is a unitary device rather than two separate and distinct components. In this embodiment of the invention, the cover sheet 12 is hingedly coupled to base sheet 2 at edge 13. Specifically, the cover sheet 12 is heat sealed to base sheet 2 along area 14 and the adhesive layer 4 is arranged on the top side of base sheet 2 except for area 14. The paper backing sheet (not shown) is applied to adhesive layer 4.

The place mat assembly 10 of FIG. 4 is sold as a kit similar to the place mat assembly of FIGS. 1-3. When the user customizes the place mat assembly 10, the cover sheet 12 is lifted from base sheet 2 by the edge of the cover sheet opposite edge 13 and the paper backing sheet is peeled from the adhesive layer 4 of base sheet 2. The objects 6 are then chosen and arranged on the adhesive layer, after which the cover sheet 12 is laid on base sheet 2 thereby forming the customized place mat.

It is understood by parents that a large portion of the day is spent attempting to feed children. It is an advantage of the place mat assembly 10 of the present invention that it can be customized in such a manner that the place mat can be used to aid in educating children during meal times. Specifically, with reference to FIGS. 5 and 6, a method for educating a child during meals is provided in which the objects 6 are specifically chosen by the user in order to aid in educating the child during meals.

In this embodiment of the invention, the place mat is customized in a similar manner as discussed above with regard to FIGS. 1-3. However, the planar objects 6 are educational objects which are chosen by a parent based on the educational level of his or her child. For example, if the child is of the age that he or she is learning simple addition or the letters of the alphabet, examples of such addition or letters are used as objects 6 and placed on the adhesive layer between the base and cover sheets. The place mat is then placed beneath the child's plate, bowl or the like during meals and the parent can quiz the child about the objects 6. For purposes of this application, it is understood by those skilled in the art that the term “educational objects” refers to objects which are used by parents solely to educate their children. Examples of such objects are numbers, letters, shapes, common objects, colors, word games, etc. The term educational objects does not refer to objects used solely for entertainment such as baseball cards and the like.

Accordingly, with the place mat assembly of the present invention, individuals are able to create customized place mats which display photographs and mementos of varying shapes and sizes in a fluid-tight manner such that the place mat can be washed without contaminating the photographs and mementos. The place mat assembly is sold as a kit and is therefore customizable by users at home or at work. In addition, the photographs and mementos can be arranged on the place mat in various ways. Moreover, the place mat can be customized to display educational objects so that the place mat can be used in order to aid in educating a child during meals.

Obviously, numerous modifications and variations of the present invention are possible in light of the teachings hereof. Therefore, it is to be understood that the invention can be varied from the detailed description above within the scope of the claims appended hereto.

What is claimed is:

1. A unitary place mat assembly for the display of at least one substantially planar object, comprising:
a substantially continuous base sheet having a first surface and a second surface, at least one of said surfaces having an adhesive layer applied thereto for retaining the planar object on said base sheet; and
a substantially continuous transparent cover sheet structured and arranged to sealably secure the planar object between said base sheet and cover sheet.

2. The place mat assembly as claimed in claim 1, wherein the at least one planar object is a plurality of planar objects having varying sizes and shapes.

3. The place mat assembly as claimed in claim 1, wherein the at least one planar object is an educational object.

4. The place mat assembly as claimed in claim 1, wherein said adhesive layer is formed from an adhesive which is sufficiently strong such that the planar objects are able to be retained between said cover sheet and said base sheet in a fluid-tight manner.

5. A method for making a place mat for displaying substantially planar objects comprising the steps of:
providing a substantially continuous base sheet having a first surface and a second surface, at least one of said surfaces having an adhesive layer applied thereto;
selecting the planar objects having any size or shape for arrangement on said adhesive layer of said base sheet;
positioning the planar objects on any area of said adhesive layer of said base sheet;
providing at least one substantially continuous transparent cover sheet; and
laying said transparent cover sheet over said continuous base sheet to thereby sealably secure said planar objects between said base sheet and said transparent cover sheet.

6. A unitary place mat assembly for the display of at least one substantially planar object, said place mat assembly having a first position and a second position, comprising:
a substantially continuous base sheet having a first surface, a second surface, a top edge, a bottom edge opposed to said top edge, and opposed side edges, at least one of said surfaces having an adhesive layer applied thereto; and
a transparent cover sheet having a top edge, a bottom edge opposed to said top edge, and opposed side edges, wherein said top edge of said cover sheet is hingedly coupled to said top edge of said base sheet such that when said place mat is in its first position, said bottom edge of said cover sheet is spaced apart from said bottom edge of said base sheet such that the planar object is able to be positioned and retained on said adhesive layer of said base sheet, and such that when said place mat is in its second position, said bottom edge of said cover sheet is flush with said bottom edge of said base sheet such that the planar object is sealably retained between said base sheet and said cover sheet.

7. A method for protecting a table top during meals, comprising the steps of:
providing a substantially continuous base sheet having a first surface and a second surface, at least one of said surfaces having an adhesive layer applied thereto;
selecting the planar object for arrangement on said adhesive layer of said base sheet;
positioning the planar object on said adhesive layer of said base sheet;
providing at least one transparent cover sheet;
laying said transparent cover sheet over said continuous base sheet to thereby sealably secure said planar objects between said base sheet and said transparent cover sheet and to thereby form a place mat;
placing the place mat on a surface of a table; and
placing dishes on the place mat.

8. A method for aiding in the education of a child during meals, comprising the steps of:
providing a substantially continuous base sheet having a first surface and a second surface, at least one of said surfaces having an adhesive layer applied thereto;
selecting an educational planar object for arrangement on said adhesive layer of said base sheet;
positioning the educational planar object on said adhesive layer of said base sheet;
providing at least one substantially continuous transparent cover sheet;
laying said transparent cover sheet over said base sheet to thereby sealably secure said educational planar objects between said base sheet and said transparent cover sheet and to thereby form a place mat;
placing the place mat on a surface of a table;
placing dishes on the place mat; and
quizzing the child regarding the educational planar objects.
